(19) United States
(12) Patent Application Publication
(10) Pub. No.: US 2026/0086870 A1
(43) Pub. Date: Mar. 26, 2026

(54) COMMUNICATION OPTIMIZATION FOR MoE BY OFFLOADING EXPERTS TO NICs

(71) Applicants: Advanced Micro Devices, Inc., Santa Clara, CA (US); XILINX, INC., San Jose, CA (US)

(72) Inventors: Kishore PUNNIYAMURTHY, Austin, TX (US); Lucian PETRICA, Dublin (IE); Venkata Pavan Kumar MIRIYALA, Singapore (SG); Kenneth O'BRIEN, Dublin (IE)

(21) Appl. No.: 18/895,644

(22) Filed: Sep. 25, 2024

(51) Int. Cl. G06F 9/50; G06N 3/045

(52) U.S. Cl. CPC G06F 9/5044; G06N 3/045; G06F 2209/503; G06F 2209/509

(57) ABSTRACT

Embodiments herein describe a system including a plurality of hardware accelerators including at least one mixture-of-experts (MoE) layer having multiple experts and a plurality of network interface cards (NICs) coupled to the plurality of hardware accelerators, wherein at least one expert of the multiple experts is offloaded from the plurality of hardware accelerators to the plurality of NICs. The plurality of hardware accelerators may be graphics processing units (GPUs). In one example, a subset of the multiple experts are selectively offloaded from the plurality of GPUs to the plurality of NICs based on memory and computational capacity available on the plurality of NICs. In another example, the multiple experts are designated as either hot experts or cold experts. The cold experts are offloaded from the plurality of GPUs to the plurality of NICs and the hot experts are duplicated for each of the plurality of GPUs.

### TECHNICAL FIELD

Examples of the present disclosure generally relate to deep learning and neural network architectures, and, in particular, to communication optimization of mixture-of-experts (MoE) by offloading one or more experts to network interface cards (NICs).

### BACKGROUND

Mixture-of-Experts (MoE) is a neural network architecture designed to improve model performance and efficiency by dynamically selecting specialized sub-networks, or “experts,” to process different parts of the input data. This approach leverages the principle that different types of data or tasks may benefit from different model structures, allowing for more targeted and efficient processing. The gating mechanism in MoE directs each input to the most appropriate expert(s) based on learned criteria, which not only enhances computational efficiency but also allows the model to scale effectively, maintaining high performance even as the size of the network increases. MoE have been particularly useful in large-scale machine learning (ML) tasks, where the need for efficient and scalable processing is paramount.

### SUMMARY

One embodiment described herein is a system including a plurality of hardware accelerators including at least one mixture-of-experts (MoE) layer having multiple experts and a plurality of network interface cards (NICs) coupled to the plurality of hardware accelerators, wherein at least one expert of the multiple experts is offloaded from the plurality of hardware accelerators to the plurality of NICs. The plurality of hardware accelerators may be graphics processing units (GPUs). In one example, a subset of the multiple experts are selectively offloaded from the plurality of GPUs to the plurality of NICs based on memory and computational capacity available on the plurality of NICs. In another example, the multiple experts are designated as either hot experts or cold experts. The cold experts are offloaded from the plurality of GPUs to the plurality of NICs and the hot experts are duplicated for each of the plurality of GPUs.

One embodiment described herein is a method including providing at least one mixture-of-experts (MoE) layer having multiple experts to a plurality of hardware accelerators coupled to a plurality of network interface cards (NICs) and offloading at least one expert of the multiple experts from the plurality of hardware accelerators to the plurality of NICs.

One embodiment described herein is a system including a plurality of hardware accelerators and a neural network architecture including multiple experts distributed across the plurality of hardware accelerators, wherein at least one expert of the multiple experts is offloaded from the plurality of hardware accelerators to a plurality of network interface cards (NICs). The multiple experts are designated as either hot experts or cold experts, the cold experts being offloaded from the plurality of hardware accelerators to the plurality of NICs and the hot experts being duplicated for each of the plurality of hardware accelerators.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a system including a plurality of graphics processing units (GPUs) each coupled to a set of smart network interface cards (NICs), where a mixture-of-experts (MoE) layer including a plurality of experts is distributed across the plurality of GPUs, according to an example.

FIG. 2 illustrates a plurality of GPUs each coupled to a set of smart NICs, where all the experts of the MoE layer are offloaded to the NICs, according to an example.

FIG. 3 illustrates a plurality of GPUs each coupled to a set of smart NICs, where a portion of the experts of the MoE layer are offloaded to the NICs, according to an example.

FIG. 4 illustrates a plurality of GPUs each coupled to a set of smart NICs, where lesser used experts (cold experts) of the MoE layer are offloaded to the NICs and the highly used experts (hot experts) of the MoE layer are processed by the GPUs, according to an example.

FIG. 5 illustrates a system for detecting the highly used experts (hot experts) of the MoE layer that are processed by the GPUs, according to an example.

FIG. 6 illustrates a plurality of GPUs each coupled to a set of smart NICs, where experts of the MoE layer are sharded across the GPUs, according to an example.

FIG. 7 illustrates a plurality of GPUs each coupled to a set of smart NICs, where sharded experts are partially offloaded to the smart NICs, according to an example.

FIG. 8 illustrates a method for offloading one or more experts of a MoE to a plurality of smart NICs, according to an example.

FIG. 9 is a block diagram of an accelerator unit (AU) configured to execute workloads for applications running on a processing system, in accordance with some embodiments.

FIG. 10 is a block diagram of a data processing unit (DPU) that may be used to implement a network interface controller/card (NIC), in accordance with some embodiments.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Mixture-of-Experts (MoE) or MoE layers are a type of neural network architecture used to improve the efficiency and scalability of machine learning (ML) models, particularly in deep learning. The idea behind MoE is to use multiple “experts” (which are typically neural network layers or sub-networks) and route each input through only a subset of these experts, rather than through the entire model. This allows the model to specialize different experts for different tasks or types of input, potentially improving both accuracy and computational efficiency.

In operation, a MoE layer includes multiple sub-models or “experts,” each of which is typically a smaller neural network. Each expert can be specialized to handle different aspects of the data or different tasks. A gating network then determines which experts should be activated for a given input. The gating network outputs a set of weights that decide how much each expert contributes to the final output. Typically, only a few experts are activated for any given input, which means not all experts are used simultaneously, leading to computational savings. One advantage of a MoE layer is that only a small number of experts are active for any given input, which makes the model more efficient. This sparsity helps in scaling up the model since adding more experts increases capacity without a proportional increase in computational cost. The gating network's decision on which experts to activate can change depending on the input. This dynamic routing allows the model to adapt to different types of data. The benefits of a MoE layer include scalability, efficiency, and specialization. MoE layers allow models to scale up to a very large number of parameters without a proportional increase in computational resources. By activating only a few experts, the MoE layer makes it possible to handle large and complex models efficiently. Different experts can learn to specialize, potentially improving the model's performance on diverse tasks. MoE layers thus represent a powerful approach in ML, enabling the creation of very large and efficient models by leveraging the strengths of multiple specialized experts.

A MoE transformer architecture is an advanced variant of the traditional transformer model that incorporates MoE layers to enhance scalability and efficiency. The MoE transformer architecture is particularly suited for handling very large models with massive numbers of parameters, which are often used for tasks like natural language processing (NLP), machine translation, and other artificial intelligence (AI)-driven tasks.

The MoE transformer may consist of an encoder and decoder (e.g., in the case of a full transformer) or just a stack of encoders (e.g., in the case of models like bidirectional encoder representations from transformers (BERT)). These components include multi-head self-attention mechanisms and feedforward neural networks. MoE layers are integrated into the transformer blocks, usually replacing or augmenting the feedforward layers within the transformer. By activating only a subset of experts, the MoE transformer reduces the number of computations needed, making it more efficient during both training and inference. This efficiency is particularly beneficial when deploying large models in production environments where computational resources are a constraint.

Sparsely-gated MoE refers to a type of MoE architecture in which only a small subset of the available experts is activated or “gated” for any given input. This approach is designed to improve the efficiency of neural networks by leveraging the power of large models while minimizing the computational cost. In a sparsely-gated MoE, only a few experts (usually 1 to 2) are activated for each input, rather than all available experts. This sparse activation means that the model does not need to compute the outputs of all experts, which significantly reduces the computational load. By only activating a small number of experts, sparsely-gated MoE can maintain a large model capacity (with many experts) without the full computational cost of using all experts simultaneously. This efficiency is beneficial for training and inference in large-scale models, allowing them to handle large datasets and complex tasks more effectively.

Distributed ML models with MoE layers incur 2× all-to-all collective communication operations as part of their execution. This collective communication operation may add significant overhead to execution time. Further, the workload distribution across experts is typically not uniform resulting in some experts being overloaded. For example, the gating network, responsible for selecting which experts to activate for each input, may introduce additional computational overhead. This is due to real-time decision-making on which experts to route the input through, which adds to the overall processing time. When experts are distributed across multiple nodes or hardware accelerators or graphics processing units (GPUs), the communication overhead between these nodes may impact performance. This includes the cost of transferring data to and from different experts, which may become significant in large-scale deployments. Moreover, if some experts are more specialized or have better performance characteristics than others, there might be an imbalance in the workload. This may lead to some experts being overused while others remain underutilized, affecting overall efficiency. The dynamic nature of routing inputs to different experts based on the gating network's decisions may lead to scenarios where certain experts receive significantly more requests than others. This imbalance can result in bottlenecks and reduced performance if not managed properly.

In view of such challenges, the example embodiments present innovative approaches to reduce overhead during execution time and to better distribute workload across the experts such that the experts are not overloaded. The example embodiments introduce systems and methods for offloading experts from GPUs to smart NICs. In one example, all of the experts are offloaded to the NICs. In another example, a subset of the experts are offloaded to the NICs. In yet another example, the experts are categorized or designated as hot experts and cold experts. The hot experts are duplicated for the GPUs and the cold experts are offloaded to the NICs. As such, hotness-aware expert offload to smart NICs is also presented to exploit skew in workload distribution across experts. In yet another embodiment, the experts are sharded across GPUs and at least a subset of the sharded experts are offloaded to the NICs. Therefore, different embodiments are presented for offloading one or more experts of a MoE layer of a plurality of GPUs to a plurality of smart NICs.

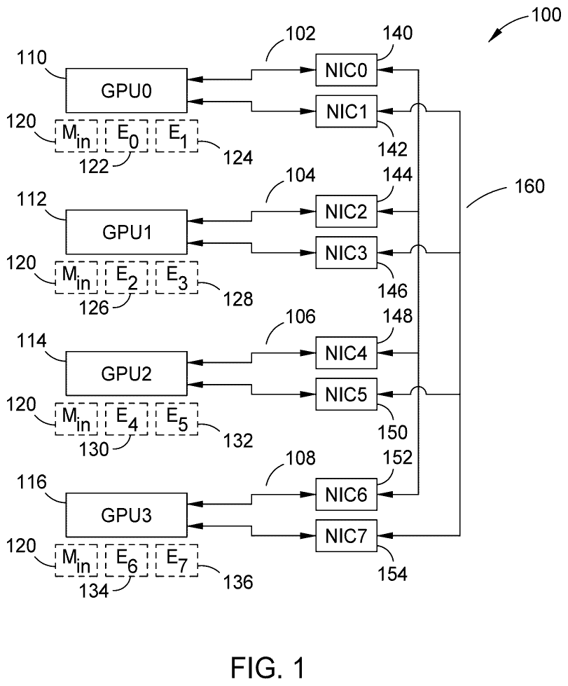

FIG. 1 illustrates a system 100 including a plurality of graphics processing units (GPUs) each coupled to a set of smart network interface cards (NICs), where a mixture-of-experts (MoE) layer including a plurality of experts is distributed across the plurality of GPUs, according to an example.

A plurality of GPUs may be coupled to a plurality of NICs. In one non-limiting example, four GPUs are presented, where each GPU is coupled to a pair of smart NICs. Any number of GPUs and any number of NICs may be used. The GPUs may be referred to as hardware accelerators. A hardware accelerator may be a specialized computing device to perform specific tasks more efficiently than a general purpose processor, such as a CPU.

For example, a first GPU 110 (GPU0) is coupled to a first smart NIC 140 (NIC0) and a second smart NIC 142 (NIC1). Communications 102 between the first GPU 110 and the first smart NIC 140 and the second smart NIC 142 are shown.

A second GPU 112 (GPU1) is coupled to a first smart NIC 144 (NIC2) and a second smart NIC 146 (NIC3). Communications 104 between the second GPU 112 and the first smart NIC 144 and the second smart NIC 146 are shown.

A third GPU 114 (GPU2) is coupled to a first smart NIC 148 (NIC4) and a second smart NIC 150 (NIC5). Communications 106 between the third GPU 114 and the first smart NIC 148 and the second smart NIC 150 are shown.

A fourth GPU 116 (GPU3) is coupled to a first smart NIC 152 (NIC6) and a second smart NIC 154 (NIC7). Communications 108 between the fourth GPU 116 and the first smart NIC 152 and the second smart NIC 154 are shown.

In one example, each GPU is associated with a pair of smart NICs. In other examples, each GPU may be associated with more than two NICs. Each GPU includes a MoE layer 115. The MoE layer 115 may include a plurality of experts. In one example, the MoE layer 115 includes 8 experts. The input to the MoE layer 115 is marked as input 120. The MoE layer 115 may include more or less experts depending on the application.

The first GPU 110 maintains a first expert 122 (E₀) and a second expert 124 (E₁). The second GPU 112 maintains a third expert 126 (E₂) and a fourth expert 128 (E₃). The third GPU 114 maintains a fifth expert 130 (E₄) and a sixth expert 132 (E₅). The fourth GPU 116 maintains a seventh expert 134 (E₆) and an eighth expert 136 (E₇). Communications 160 between the smart NICs are shown. In a forward pass, all of the GPUs perform two all-to-all operations to distribute the inputs to the corresponding experts and combine their output.

A GPU (e.g., the first GPU 110, the second GPU 112, the third GPU 114, and the fourth GPU 116)) is a specialized electronic circuit designed to accelerate the processing of images and videos by efficiently handling parallel operations. GPUs have evolved to perform complex computations in fields, such as artificial intelligence (AI), scientific simulations, and data analytics. Unlike a central processing unit (CPU), which is optimized for general-purpose tasks, a GPU is highly parallelized, meaning it can perform many calculations simultaneously. This makes the GPU particularly effective for tasks like matrix operations and deep learning, where large-scale data processing is involved.

A smart NIC (e.g., NIC0, NIC1, NIC2, NIC3, NIC4, NIC5, NIC6, NIC7) is an advanced network interface card that includes additional processing power and specialized hardware, such as programmable processors to offload and accelerate various networking and storage tasks from the main CPU. Unlike traditional NICs, which primarily handle basic networking functions like packet transmission and reception, smart NICs can manage more complex tasks, such as encryption/decryption, traffic shaping, load balancing, and virtualization tasks like virtual switching. This offloading capability improves network performance, reduces CPU load, and enhances the overall efficiency of data centers, particularly in high-performance computing environments and cloud infrastructures. The GPUs (e.g., the first GPU 110, the second GPU 112, the third GPU 114, and the fourth GPU 116) are designed to offload one or more experts or subsets of experts to the smart NICs (e.g., NIC0, NIC1, NIC2, NIC3, NIC4, NIC5, NIC6, NIC7).

Offloading refers to the process of delegating certain computations or tasks to specialized hardware or components to improve efficiency and performance. When experts of the MOE model are offloaded to the smart NICs, it means that some of the computational tasks related to these experts are handled by the NICs instead of the GPUs. By offloading certain tasks to NICs, the computational burden on the GPUs is reduced, freeing up the GPUs for other critical tasks and improving overall system performance. Offloading computational tasks to NICs can also reduce communication latency, as NICs can handle data transfers closer to the network interface.

The MoE layer 115 is a specialized neural network layer designed to increase the model's capacity and efficiency by leveraging multiple “experts” (i.e., smaller sub-networks) and dynamically selecting a subset of these experts to process each input. The MoE layer 115 consists of experts, gating networks, sparse activation, and a combination mechanism.

Experts (i.e., E₀, E₁, E₂, E₃, E₄, E₅, E₆, and E₇) are individual neural networks (usually feedforward layers) that make up the core computational units within the MoE layer 115. Each expert is typically a fully connected layer with its own set of weights and biases, and often includes activation functions like ReLU. The MoE layer 115 may comprise many experts, sometimes ranging from a few dozen to hundreds or even thousands, depending on the model's design.

The gating network is responsible for selecting which experts will be activated for a given input. Given an input, the gating network produces a set of scores or probabilities indicating how relevant each expert is for that input. Usually, only the top-k experts (based on the highest scores) are selected and activated. This “sparse” selection is a valuable feature of MoE layers, leading to computational efficiency. The gating network is often a small neural network itself, typically a simple feedforward network that outputs a softmax distribution over the experts.

After the gating network determines the top-k experts, only these selected experts are used to process the input, while the rest are inactive. This sparse activation allows the model to leverage a large number of parameters (from many experts) without incurring the full computational cost of using all experts simultaneously. The outputs of the selected experts are typically combined using a weighted sum, where the weights are determined by the gating network's scores. The aggregated output from the experts is then passed on to the next layer in the neural network, continuing the model's processing of the input.

An all-to-all operation is a communication pattern commonly used in parallel and distributed computing environments, where every participant (or node) in a system exchanges data with every other participant. In the context of ML, particularly in distributed training and models that use MoE layers, all-to-all operations are beneficial for coordinating the flow of data among different parts of the model that might be distributed across multiple devices or machines.

In an all-to-all operation, each node sends data to every other node and simultaneously receives data from every other node. This ensures that all nodes have access to the information from every other node. In distributed training of large ML models, especially those with MoE layers, all-to-all operations are used to share the outputs of experts across different devices. In distributed MoE execution, two all-to-all operations are used. A first all-to-all operations is used to distribute the inputs to GPUs containing the expert responsible for processing them. For example, M_in (matrix of inputs) will be distributed across 4 GPUs using the all-to-all operation such that the inputs are sent to the expert decided by the gating function. The second all-to-all operation is used for gathering the outputs from individual experts back to the original GPUs.

In other words, in the MoE layer 115, different experts might be distributed across different devices or nodes. After each device computes the outputs of its local experts, an all-to-all operation is used to exchange these outputs among all devices so that each device can combine the outputs from the selected experts. This pattern ensures that each device has access to the outputs from the experts selected by the gating network, regardless of which device the experts reside on.

Referring back to FIG. 1, if T (GPUcomp) is the time a GPU needs to perform a feed-forward general matrix multiply (GEMM) computation for one expert, then Sizein is the message size for the all-to-all operations. It is assumed that all experts are equally subscribed (i.e., the workload of all the experts is same).

The time of this operation is given as:

$$T ( GPUcomp ) \times ExpertsPerGPU + T ( All - to - {All}_{dispatch} , {Size}_{in} ) + T ( All - to - {All}_{combine} , {Size}_{in} )$$

According to FIG. 1, offloading experts of a MoE to smart NICs is an advanced technique aimed at improving the efficiency and scalability of distributed machine learning models. By leveraging NICs, particularly those with advanced processing capabilities, the burden of managing and routing data between experts can be reduced, leading to faster and more efficient distributed training and inference. The benefits of offloading experts from the GPU to smart NICs include reduced latency, increased throughput, lower GPU utilization, and scalability. Offloading communication tasks to NICs can significantly reduce the latency involved in data transfer between experts, which is beneficial in distributed systems where communication can be a bottleneck. By freeing up the GPU from managing data routing and possibly some expert computation, overall throughput can be increased. This is especially important in large-scale MoE models where the number of experts and the volume of data can be very high. Offloading tasks to NICs allows GPUs to focus on the core computations of the model, which can lead to better overall system performance and allow for more complex models to be run on the same hardware. NIC offloading can help in scaling MoE models more effectively, as the burden of managing inter-expert communication across distributed systems is reduced. This is particularly beneficial when dealing with large clusters of machines.

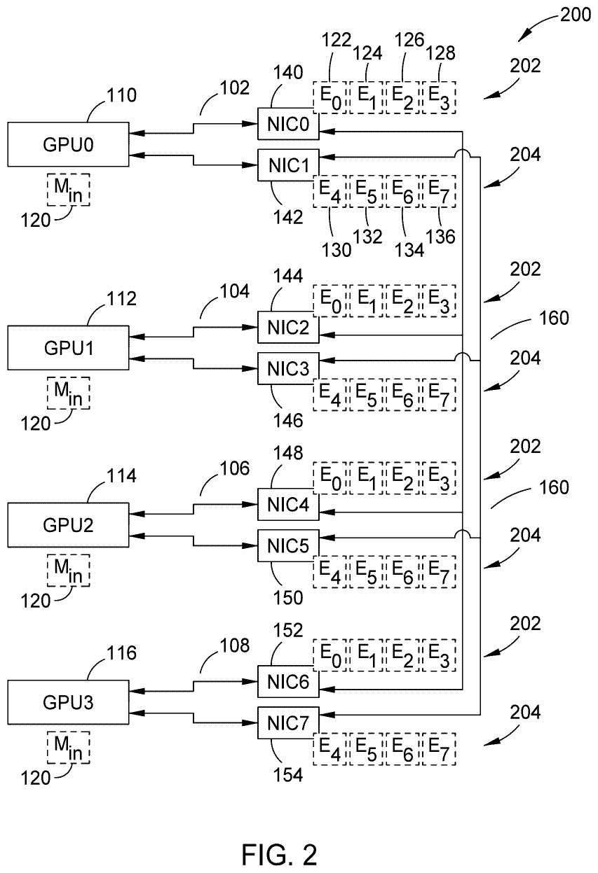

FIG. 2 illustrates a plurality of GPUs each coupled to a set of smart NICs, where all the experts of the MoE layer are offloaded to the NICs, according to an example.

One way to offload experts to smart NICs to minimize communication is by offloading all of the experts to the smart NICs resulting in a configuration as shown in the system 200 of FIG. 2. In the example, each smart NIC holds four experts and all experts are available between the two smart NICs coupled to each GPU. This completely avoids the need to perform the all-to-all collective operations. Instead, the communication involves copying the input tensors from GPU high bandwidth memory (HBM) to the smart NIC memory for computation and sending the results back to GPU HBM memory.

As shown, for the first GPU 110 (GPU0) a first subset of experts 202 are handled by the first NIC (NIC0) and a second subset of experts 204 are handled by the second NIC (NIC1).

For the second GPU 112 (GPU1) the first subset of experts 202 are handled by the first NIC (NIC2) and the second subset of experts 204 are handled by the second NIC (NIC3).

For the third GPU 114 (GPU2) the first subset of experts 202 are handled by the first NIC (NIC4) and the second subset of experts 204 are handled by the second NIC (NIC5).

For the fourth GPU 116 (GPU3) the first subset of experts 202 are handled by the first NIC (NIC6) and the second subset of experts 204 are handled by the second NIC (NIC7).

Thus, all of the experts have been assigned to NICs. Each NIC handles a subset of the experts. In this example, each NIC handles 4 experts.

If T (NICcomp) is the time needed by a GPU to perform feed-forward GEMM computation for one expert, the time, for no pipeline, is given as:

$$T ( NICcomp ) \times expertsPerNIC + T ( copy input GPU \to NIC , {Size}_{in} ) + T ( copy results NIC \to GPU , {Size}_{in} )$$

The data copy to/from NIC can be pipelined (e.g., one expert at a time) resulting in the pipelined time given as:

$$max ( T ( copy input GPU \to NIC , {Size}_{in} / expertsPerNIC + T ( copy results NIC \to GPU , {Size}_{in} / expertsPerNIC ) , T ( NICcomp ) ) \times expertsPerNIC$$

While this approach eliminates the all-to-all collective operations completely, such approach may add a computation burden on smart NICs while under-utilizing the GPUs (assuming there is no parallel computation available for GPUs to perform). Further, smart NICs have large memory capacity for this approach to be viable, where each smart NIC will need to store weights corresponding to four experts in the example shown in FIG. 2.

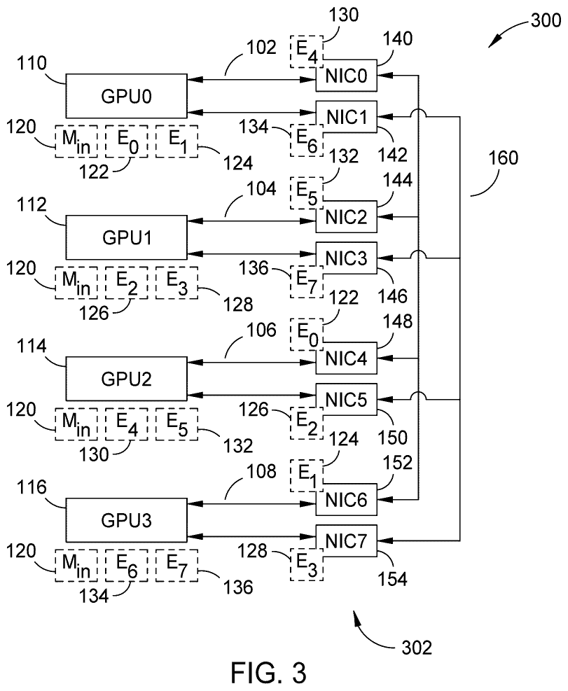

FIG. 3 illustrates a plurality of GPUs each coupled to a set of smart NICs, where a portion of the experts of the MoE layer are offloaded to the NICs, according to an example.

Instead of offloading all the experts to smart NICs as in FIG. 2, the system 300 can selectively offload some or a portion or a subset of the experts depending on the memory and computational capacity available per smart NIC. In FIG. 3, one expert is offloaded per smart NIC, as shown by arrow 302. While this approach does not completely eliminate the all-to-all collective operations, such approach reduces the amount of data to be distributed with the all-to-all operations, as now four experts (e.g., E₀, E₁, E₄, and E₆ for GPU0) are available per GPU. Subsequently, the input sizes for feed-forward layers within expert layers and amount of data communicated across GPUs are smaller resulting in lower computation time.

If it is assumed that “k” is the number of experts offloaded per NIC, and N is the total number of experts (e.g., 8), then it may be assumed that each expert is duplicated d times (d=1 in example) across the NICs (e.g., E₀ is present in GPU0, and NIC4).

The time is given as:

$$T ( copy input GPU \to NIC , ( k / N ) \times {Size}_{in} ) + T ( copy results NIC \to GPU , ( k / N ) \times {Size}_{in} ) + max ( T ( GPUcomp ) \times ExpertsPerGPU \times ( 1 - d / numGPUs ) , T ( NICcomp ) \times expertsPerNIC \times ( k / numGPUs ) ) + T ( All - to - {All}_{dispatch} , ( 1 - ( k \times nicsPerGPU ) / N ) \times {Size}_{in} ) + T ( All - to - {All}_{combine} , ( 1 - ( k \times nicsPerGPU ) / N ) \times {Size}_{in} )$$

For example in FIG. 3, the time is given as:

$$T ( copy input GPU \to NIC , ( 1 / 8 ) \times {Size}_{in} ) + T ( copy results NIC \to GPU , ( 1 / 8 ) \times {Size}_{in} ) + max ( T ( GPUcomp ) \times ExpertsPerGPU \times ( 3 / 4 ) , T ( NICcomp ) \times expertsPerNIC \times ( 1 / 4 ) ) + T ( All - to - {All}_{dispatch} , ( 3 / 4 ) \times {Size}_{in} ) + T ( All - to - Allcombine , ( 3 / 4 ) \times Sizein )$$

Therefore, selectively offloading some of the experts or a subset of the experts of a MoE model to a plurality of smart NICs, rather than all experts, is a strategic approach aimed at optimizing performance, resource utilization, and system architecture. This selective offloading is based on various factors such as the specific characteristics of the experts, the computational capabilities of the smart NICs, and the overall system design.

Reasons for selective offloading include resource constraints of smart NICs, workload characteristics, optimizing network bandwidth and latency, energy efficiency, balancing system loads, and scalability and flexibility considerations.

While smart NICs are powerful, they typically have less processing power compared to CPUs or GPUs. Offloading all the experts to smart NICs might overwhelm their capabilities, leading to suboptimal performance (as noted in FIG. 2). Smart NICs generally have limited memory compared to the host system. Offloading only a subset of experts ensures that the smart NIC's memory is used effectively without running out of resources. Not all expert computations may be well-suited for the specialized processing units on smart NICs. Some experts might process complex operations that are better handled by the GPU.

In a MoE model, different experts might perform different types of computations. Some experts might have simple, repetitive tasks that are ideal for offloading to a smart NIC, while others may have more complex tasks that are better suited for the GPU. Experts that are less latency-sensitive or involve straightforward computations might be offloaded to smart NICs to free up the GPU for more latency-sensitive or computationally intensive tasks.

Experts that handle data involving frequent network communication might be offloaded to smart NICs to reduce the data transfer time between the network and the processing units, leveraging the proximity of the NIC to the network interface. Selectively offloading certain experts can help avoid creating network bottlenecks. If all experts were offloaded, as in FIG. 2, the NIC might become a communication bottleneck, especially if the network traffic is heavy.

Smart NICs are generally more power-efficient for certain types of operations compared to GPUs. Offloading only the experts that can benefit from this efficiency helps in reducing overall energy consumption without compromising performance. Concentrating all computational tasks on the smart NIC could lead to thermal issues, as these devices have limited cooling capabilities compared to GPUs. Selective offloading helps in managing heat dissipation effectively.

By selectively offloading experts, as illustrated in FIG. 3, the system 300 can better distribute computational loads across different components. This load balancing helps in optimizing the performance of the entire system, preventing any single component from becoming a performance bottleneck. The system 300 can dynamically decide which experts to offload based on real-time metrics such as GPU load, network traffic, and smart NIC utilization, leading to more flexible and adaptive resource management.

Moreover, some experts may be specialized in tasks that are inherently parallelizable and suitable for offloading to smart NICs, such as packet processing or simple feedforward operations. Other experts, especially those involving complex data dependencies or deep computational graphs, may be better suited for GPU processing. Thus, by considering the specific characteristics of each expert, the capabilities of the smart NIC, and the overall system architecture, only those experts that are well-suited to the smart NIC's capabilities are offloaded. This ensures that the system remains balanced, scalable, and cost-effective, while maximizing the benefits of using smart NICs in distributed machine learning models.

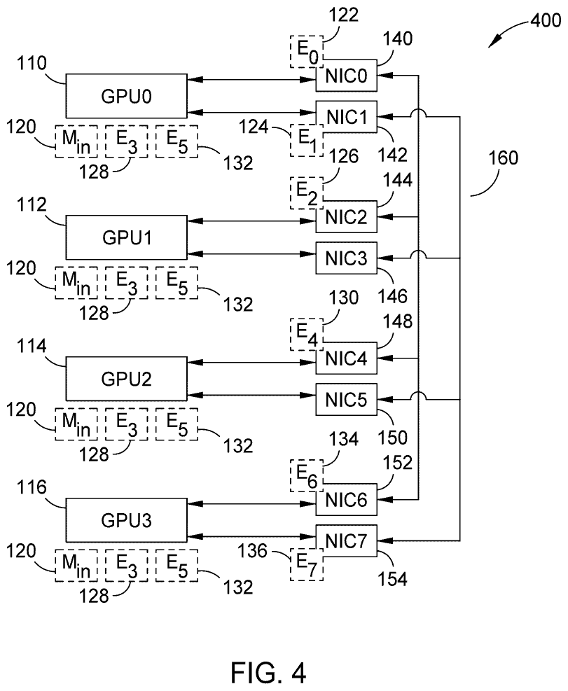

FIG. 4 illustrates a plurality of GPUs each coupled to a set of smart NICs, where lesser used experts (cold experts) of the MoE layer are offloaded to the NICs and the highly used experts (hot experts) of the MoE layer are processed by the GPUs, according to an example.

MoE often suffers from uneven workload distribution across experts resulting in some experts being over-subscribed while other experts having lower tokens assigned. In such cases, the system 400 can detect, and duplicate the hot experts and offload the cold experts to the NICs to improve load balancing to minimize communication skew. Communication skew may refer to an imbalance or inefficiency in the way communication or data exchange is handled in distributed systems or parallel computing environments. Communication skew occurs when processes or nodes (e.g., experts of the MoE layer 115) are burdened with more communication or data transfer tasks than others, leading to inefficiencies and performance bottlenecks.

In MoE models, “hotness” refers to the frequency or intensity with which certain experts are activated. Some experts are “hot,” meaning they are selected more often by the gating network due to their relevance to a large portion of the input data. MoE models often exhibit an imbalance in expert utilization, where a small number of experts are activated frequently (hot experts) while others are rarely used (cold experts). Instead of offloading all experts to NICs, partial offloading focuses on offloading only a subset of experts. This is done based on various criteria, such as resource constraints or the specific nature of the tasks performed by the experts. In hotness-aware partial expert offloading, the decision on which experts to offload is based on their hotness. Colder experts are candidates for offloading to NICs.

Therefore, in a MoE model, the terms “hot expert” and “cold expert” refer to the activation state of the individual experts within the network. An expert is considered “hot” when it is actively contributing to the output of the model. This means that the gating network has assigned a high weight or importance to this expert for a given input. Essentially, a hot expert is one that is being utilized and is playing a significant role in the current decision-making process. Conversely, a “cold” expert is one that is not actively contributing to the output for a particular input. This happens when the gating network assigns a low weight or importance to this expert, meaning it is not significantly influencing the model's prediction or output at that moment. The dynamic nature of which experts are hot or cold allows the MoE model to efficiently allocate resources and adapt to different types of inputs or tasks, enhancing the overall performance of the model by focusing computational resources on the most relevant experts.

In the system 400, it is assumed that experts E₃ and E₅ are hot experts. Once the hot experts have been detected, the hot experts can be duplicated across GPUs and the cold experts which were originally mapped to the GPUs can be offloaded to the smart NICs. Since the hot experts to which most of the tokens are directed are duplicated, this significantly reduces the amount of data to be exchanged using all-to-all operations. Further, the cold experts are offloaded to smart NICs (with potentially lower compute capability than GPUs), which can be executed in parallel.

The time is given as:

$$Time = max ( T ( GPUcomp - Hot experts ) \times expertsPerGPU , T ( NICcomp - cold experts ) \times expertsPerNIC + T ( All - to - {All}_{dispatch} , {Size}_{coldExperts} ) + T ( All - to - {All}_{combine} , {Size}_{coldExperts} ) )$$

As such, FIG. 4 relates to hotness-aware expert offloading. Hotness-aware expert offload is a strategy used in MoE models, particularly in the context of offloading some of the experts to smart NICs. This approach leverages the “hotness” of the experts, that is, how frequently or intensively each expert is utilized, to determine which experts should be offloaded to NICs.

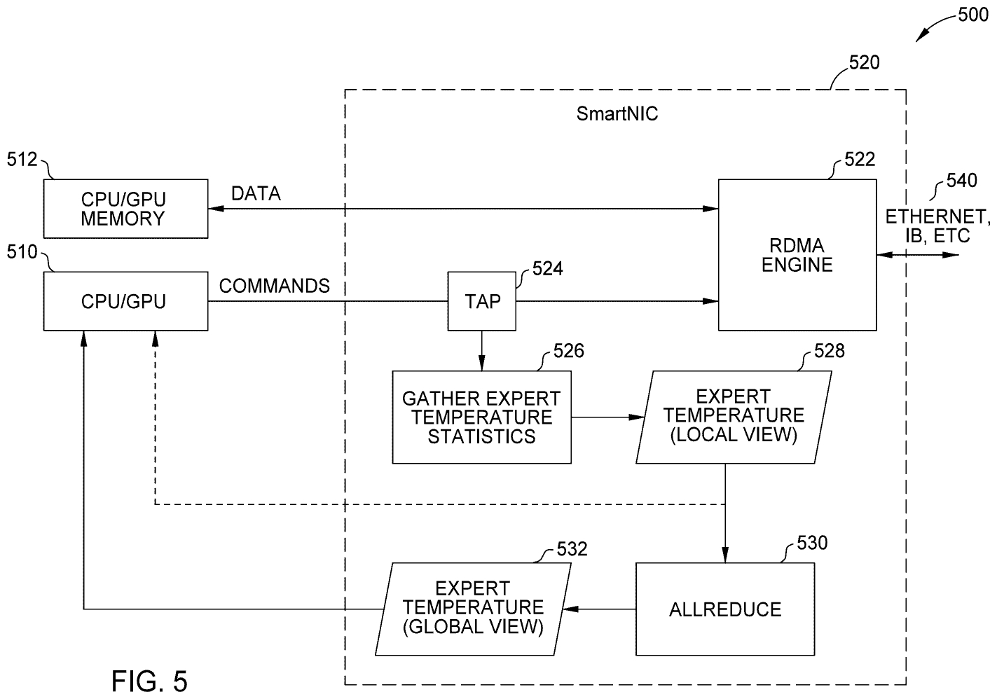

FIG. 5 illustrates a system for detecting the highly used experts (hot experts) of the MoE layer that are processed by the GPUs, according to an example.

FIG. 5 illustrates how expert temperature can be gathered by the smart NIC automatically by inspecting the expert traffic between compute nodes via the smart NIC. Commands by the GPU/CPU are monitored by logic executing in the smart NIC to determine, based on, e.g., addresses, queue numbers or other metadata, the targeted experts for each communication round. With this information each smart NIC can build a temperature estimate from its own perspective. Subsequently, a global view of expert temperatures can be creating by performing a reduction of the local views across all of the smart NICs involved in the communication round. This allreduce may be performed automatically, without user intervention, at specific pre-defined or user-defined triggers, e.g. after a specific time or after a specific number of communication rounds, etc. The CPU/GPU may access either the local or global hotness data to determine expert offload strategy.

Referring back to the system 500, the CPU/GPU 510 includes memory 512. The CPU/GPU 510 communicates with the smart NIC 520. The smart NIC 520 includes a remote direct access memory (RDMA) engine 522. The RDMA engine 522 is a hardware component designed to facilitate direct memory access between the memory 512 and other hardware connected via, e.g., the Ethernet connection 540. The RDMA engine 522 enables high-speed data transfers with low latency and minimal CPU/GPU usage overhead.

A tap 524 is coupled between the CPU/GPU 510 and the RDMA engine 522. The tap 524 is a tap access point or network tap or monitoring device. The tap 524 is used to capture network packets to monitor and analyze without interrupting the network traffic. For example, the tap 524 allows for capturing and analyzing RDMA traffic, which is useful for performance monitoring. The tap 524 may gather expert temperature statistics via an expert temperature statistics device 526. The expert temperature statistics device 526 gathers expert temperatures at a local view 528 and at a global view 532.

The local view 528 refers to the temperature statistics gathered for each individual expert. This may include metrics like how frequently an expert is activated (hot) versus how often it remains idle (cold). By tracking such statistics, the system 500 can assess how well each expert is being utilized.

The global view 532 aggregates temperature statistics across all experts in the MOE system. The global view 532 provides an overview of the overall distribution of expertise activation and utilization. The global view 532 thus helps identify patterns, such as which experts are consistently hot or cold, and whether there are any imbalances in the load distribution across experts.

The term “temperature” relates to the concept of “activation frequency” or “usage.” Hot experts are those that are frequently activated and used and cold experts are those that are rarely used. Monitoring temperature statistics helps in optimizing the allocation of tasks and resources among the experts.

Additionally, an allreduce function 530 may be used before providing the expert temperatures at the global view 532. The allreduce function 530 performs a reduction (e.g., sum, average, max) on data distributed across different modes or experts and then distributes the result back to all the participating nodes. This ensures that all the nodes have access to the aggregated data. For example, the allreduce function 530 aggregates the local temperature statistics across all experts to produce the global view 532. That is, if each node has counts of how often each expert was active, the allreduce function 530 would sum these counts across all nodes to obtain a total count for each expert. This aggregated view helps in understanding the global distribution of workload and performance. This information can also be used to adjust the gating mechanism, balance the load, or optimize the use of the experts. Thus, this information is fed back to the CPU/GPU 510.

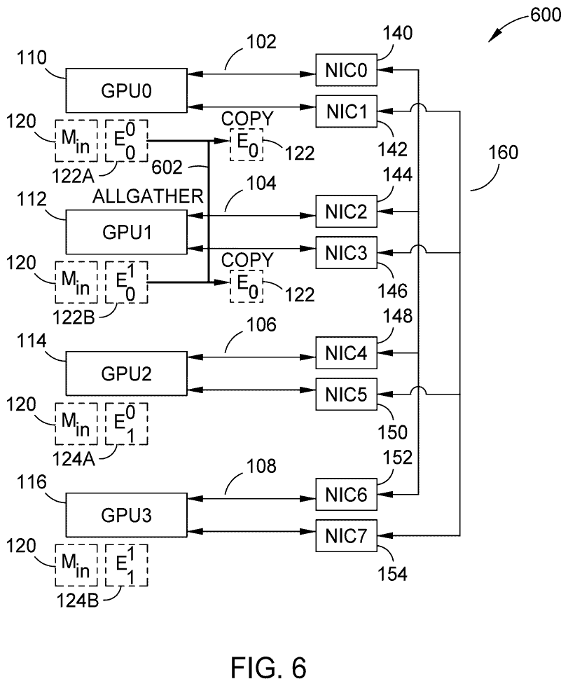

FIG. 6 illustrates a plurality of GPUs each coupled to a set of smart NICs, where experts of the MoE layer are sharded across the GPUs, according to an example.

In a MoE model, a sharded expert refers to a technique used to distribute the computational load of an expert across multiple devices or nodes. This is particularly useful in large-scale MoE models where the size and computational demands of individual experts exceed the capacity of a single device. Sharding helps manage these demands by breaking down the expert into smaller, more manageable parts that can be distributed and processed in parallel.

Sharding involves splitting an expert into multiple shards or segments, each of which handles a portion of the expert's workload. These shards can be distributed across different devices or nodes in a distributed computing system. The primary goal of sharding is to scale the expert's capacity beyond the limits of a single device by leveraging the collective processing power of multiple devices. The sharding process includes partitioning, distribution, and aggregation. In partitioning, the expert's computation is partitioned into several shards. Each shard performs a subset of the computations that the expert is responsible for. In distribution, the shards are distributed across multiple devices or nodes. Each device or node processes its assigned shard and then communicates with other devices to share results. In aggregation, after processing, the results from all shards are aggregated to produce the final output. This aggregation can occur at different stages depending on the architecture and design of the MoE model.

The benefits of sharding experts includes, scalability, efficient resource utilization, and use of larger experts. Sharding allows MoE models to scale by distributing the computational load of large experts across multiple devices, making it possible to handle larger models and datasets. By leveraging the combined processing power of multiple devices, sharding helps utilize available resources more efficiently, reducing the risk of bottlenecks. Sharding enables the use of larger experts that would otherwise be infeasible to fit on a single device, making it possible to build more complex and capable MoE models.

Referring back to FIG. 6, the system 600 depicts two experts sharded across four GPUs. The forward pass of this MoE layer will use an allgather operation or function to combine individual shards of experts (shown by the line 602) on top of performing both all-to-all operations (i.e., dispatch and combine).

For example, in the system 600, the first expert E₀ is sharded or divided or split into two segments, that is,

$${E}_{0}^{0} ( 122 A ) and {E}_{0}^{1} ( 122 B ) .$$

Also, the second expert E₁ is sharded or divided or split into two segments, that is,

$${E}_{1}^{0} and {E}_{1}^{1} .$$

The first expert E₀ is sharded across the first GPU 110 (GPU0) and the second GPU 112 (GPU1). The first expert shard

$${E}_{0}^{0}$$

is associated with the first GPU 110 and the second expert shard

$${E}_{0}^{1}$$

is associated with the second GPU 112. An allgather operation is performed to combine the two segments, that is,

$${E}_{0}^{0} and {E}_{0}^{1}$$

back to E₀. The allgather operation allows each process or node or expert to gather data from all nodes or experts and then share this gathered data with all the nodes or experts. Essentially, every node or expert ends up with a complete copy of the data collected from all the nodes or experts. In other words, each node sends it local data to all other nodes, and each node collects the data from all other nodes, and each node assembles the gathered data into a complete set and makes it available to itself and all the other nodes (or experts).

Similarly, the second expert E₁ is sharded across the third GPU 114 (GPU2) and the fourth GPU 116 (GPU3). The second expert shard

$${E}_{1}^{0} ( 124 A )$$

is associated with the third GPU 114 and the second expert shard

$${E}_{1}^{1} ( 124 B )$$

is associated with the fourth GPU 116. The allgather operation is performed to combine the two segments, that is,

$${E}_{1}^{0} and {E}_{1}^{1}$$

back to E₁. The allgather operation is performed so that every GPU can temporarily recreate the entire expert within themselves. For example, the second shard can be communicated from GPU1 to GPU0 and the first shard can be communicated from GPU0 to GPU1, as part of the allgather operation, so that both GPUs (GPU0 and GPU1) have their own complete copy of the expert.

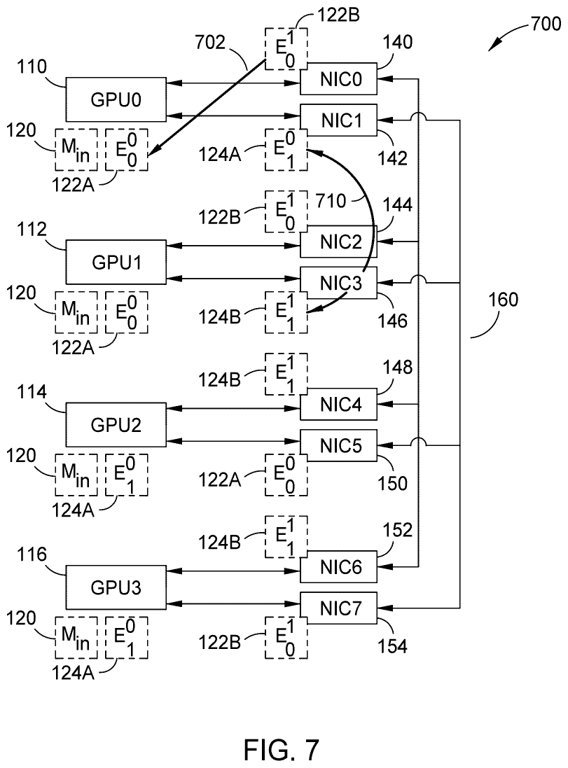

FIG. 7 illustrates a plurality of GPUs each coupled to a set of smart NICs, where sharded experts are partially offloaded to the smart NICs, according to an example.

A sharded expert in a MoE model refers to the practice of splitting an expert into multiple smaller shards, which are then distributed across different devices or nodes. This approach allows for handling large and computationally intensive experts by leveraging the combined processing power of multiple devices. Sharding improves scalability, resource utilization, and the ability to manage large models, but it also introduces challenges such as communication overhead, synchronization, and load balancing. Effective implementation of sharded experts involves careful consideration of shard size, aggregation strategies, and efficient communication protocols.

FIG. 7 enables partial offload of sharded experts to smart NICs to eliminate the allgather operation and reduce (and potentially eliminate) the all-to-all operation.

The system 700 depicts sharded experts offloaded to smart NICs such that the need for the allgather function or operation is eliminated. In each GPU, the missing shards of expert are duplicated in one of the NICs. For example, for GPU0, the missing shard

$${E}_{0}^{1} ( 122 B )$$

is duplicated NIC0. The complete expert can be obtained by copying the shard from the NIC to the GPU, as shown by arrow 702.

In addition to duplicating the missing shard per GPU, the example methods also propose using any additional NIC memory capacity (e.g., NIC1 for GPU0) to duplicate other expert shards. In FIG. 7, NIC1 contains a copy of a shard of the other expert

$${E}_{1}^{0} .$$

Instead of doing all-to-all operation (i.e., dispatch and combine), the example methods instead gather the shards between the GPUs (e.g., {NIC1, NIC3} and {NIC5, NIC7}) execute an allgather function among themselves (arrow 710) to obtain the full experts E₁ and E₀, respectively. Doing this eliminates the need to distribute inputs across the GPUs using the all-to-all function, as each GPU has both experts (one in the local HBM and other in the NIC memory). Communication used to combine shards of both experts involves different communication links. For example, for GPU0, E₀ is obtained by copying shard from NIC0→GPU 0, while E₁ is obtained by communicating over NIC1↔NIC3 links. Since there were only two experts in the layer and the GPUs each have two NICs (effectively memory capacity to hold two shards), the example methods are able to completely eliminate the all-to-all operation. However, in other cases, all-to-all operations may still be used, as the amount of data being communicated using the all-to-all is reduced.

By offloading sharded experts to NICs, the need for frequent allgather and all-to-all communication operations is reduced, which are typically expensive in terms of network bandwidth and latency. NICs with built-in computation capabilities can handle more local computations, thereby lessening the load on the network. With shards residing on NICs, the communication between different parts of the model can occur directly through the NICs, bypassing the need for extensive inter-node communication. This direct communication can significantly lower latency for data transfer and computations. Offloading computations (of sharded experts) to NICs can help improve scalability by minimizing the need for extensive communication between nodes. This allows for better utilization of resources and can make it easier to scale the model across a larger number of nodes or GPUs.

Moreover, duplicating shards on NICs means that the computation involved for each shard can be performed locally on the NIC, which can reduce the computational load on the main processors (e.g., GPUs). This can lead to better overall efficiency and performance of the distributed model. By leveraging NICs for some of the computational work, GPU resources can be freed up for other tasks, such as training or inference, thereby improving the overall throughput of the system. Since NICs can handle local computations, they can keep the data close to where it's processed, reducing the need to move data across the network and improving data locality.

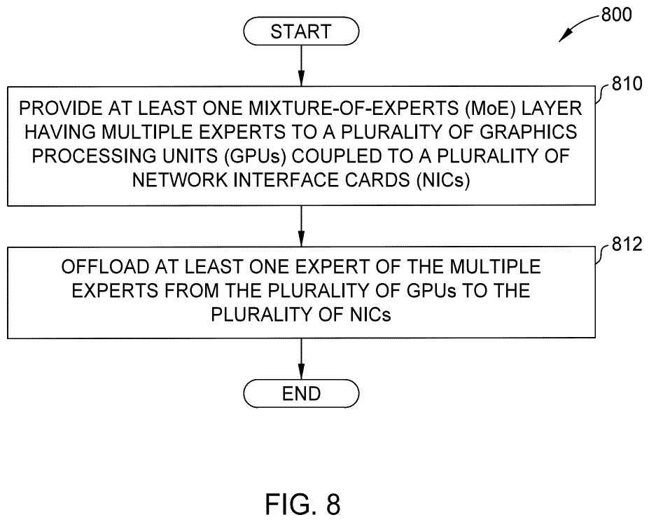

FIG. 8 illustrates a method 800 for offloading experts of a MoE to a plurality of smart NICs, according to an example.

At block 810, provide at least one mixture-of-experts (MoE) layer having multiple experts to a plurality of graphics processing units (GPUs) coupled to a plurality of network interface cards (NICs). The MoE layer 115 may include a plurality of experts. In one example, the MoE layer 115 includes 8 experts. The MoE layer 115 may include more or less experts depending on the application.

At block 820, offload at least one expert of the multiple experts from the plurality of GPUs to the plurality of NICs. Offloading experts of a MoE to smart NICs is an advanced technique aimed at improving the efficiency and scalability of distributed machine learning models. By leveraging NICs, particularly those with advanced processing capabilities, the burden of managing and routing data between experts can be reduced, leading to faster and more efficient distributed training and inference. The benefits of offloading experts from the GPU to smart NICs include reduced latency, increased throughput, lower GPU utilization, and scalability.

The benefits of offloading experts from the GPU to smart NICs include reduced latency, increased throughput, lower GPU utilization, and scalability. Offloading communication tasks to NICs can significantly reduce the latency involved in data transfer between experts, which is beneficial in distributed systems where communication can be a bottleneck. By freeing up the GPU from managing data routing and possibly some expert computation, overall throughput can be increased. This is especially important in large-scale MoE models where the number of experts and the volume of data can be very high. Offloading tasks to NICs allows GPUs to focus on the core computations of the model, which can lead to better overall system performance and allow for more complex models to be run on the same hardware. NIC offloading can help in scaling MoE models more effectively, as the burden of managing inter-expert communication across distributed systems is reduced.

In conclusion, the example embodiments present innovative approaches to reduce overhead during execution time and to better distribute workload across the experts such that the experts are not overloaded. The example embodiments introduce systems and methods for offloading experts from GPUs to smart NICs. In one example, all of the experts are offloaded to the NICs. In another example, a subset of the experts are offloaded to the NICs. In yet another example, the experts are categorized or designated as hot experts and cold experts. The hot experts are duplicated for the GPUs and the cold experts are offloaded to the NICs. As such, hotness-aware expert offload to smart NICs is also presented to exploit skew in workload distribution across experts. In yet another embodiment, the experts are sharded across GPUs and at least a subset of the sharded experts are offloaded to the NICs. Therefore, different embodiments are presented for offloading one or more experts of a MoE layer of a plurality of GPUs to a plurality of smart NICs.

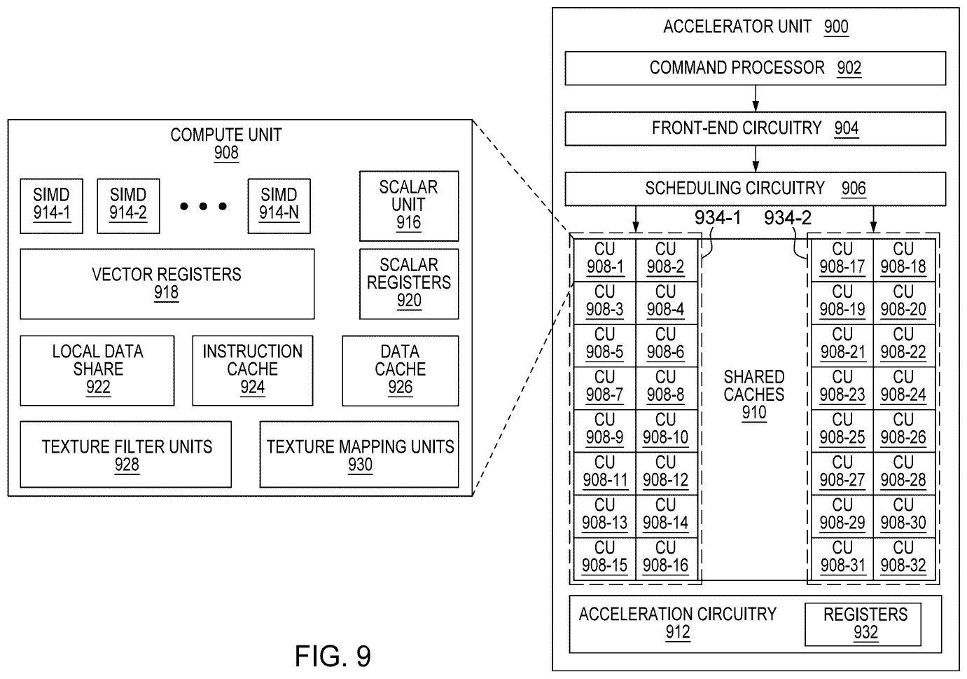

FIG. 9 is a block diagram of an accelerator unit (AU) configured to execute workloads for applications running on a processing system, in accordance with some embodiments.

FIG. 9 presents an AU 900 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 900. To perform these workgroups, AU 900 includes one or more vector processors, coprocessors, graphics processing units (GPUs), general-purpose GPUs, non-scalar processors, highly parallel processors, artificial intelligence (AI) processors, inference engines, machine-learning processors, or any combination thereof. As an example, AU 900 includes one or more command processors 902, front-end circuitry 904, scheduling circuitry 906, compute units 908, shared caches 910, and acceleration circuitry 912.

A command processor 902 of AU 900 is configured to receive, from the CPU, a command stream indicating one or more workgroups to be executed. As an example, based on a compute application running on the processing system, the command processor 902 receives a command stream indicating workgroups that require compute operations such as matrix multiplication, addition, subtraction, and the like to be performed. As another example, based on a graphics application running on the processing system, the command processor 902 receives a command stream indicating workgroups that include draw calls for a scene to be rendered. After receiving a command stream, the command processor 902 parses the command stream and issues respective instructions of the indicated workgroups to front-end circuitry 904, scheduling circuitry 906, or both. As an example, based on a command stream from a graphics application, the command processor 902 issues one or more draw calls to front-end circuitry 904 that includes one or more vertex shaders, polygon list builders, and the like. From the instructions issued from the command processor 902, front-end circuitry 904 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 902, font-end circuitry 904 determines a list of primitives to be rendered for a scene. After determining a list of primitives to be rendered for a scene, the front-end circuitry 904 issues one or more draw calls (e.g., a workgroup) associated with the primitives in the list of primitives to scheduling circuitry 906.

Based on the instructions of the workgroups received from a command processor 902, front-end circuitry 904, or both, scheduler circuitry 906 is configured to provide data indicating threads (e.g., operations for these threads) to be executed for these workgroups to one or more compute units 908. Each compute unit 908 is configured to support the concurrent execution of two or more threads of a workgroup. For example, each compute unit 908 is configured to concurrently execute a predetermined number of threads referred to herein as a “wavefront.” Based on the size of the wavefront of a compute unit 908, scheduler circuitry 906 schedules one or more groups of threads of the workgroup, also referred to herein as “waves,” to be executed by the compute unit 908. As an example, scheduler circuitry 906 first updates one or more registers of a compute unit 908 such that the compute unit 908 is configured to execute a first group of waves of the workgroup. After the compute unit 908 has executed the first group of waves, scheduler circuitry 906 updates one or more registers of the compute unit 908 to schedule a second group of waves of the workgroup to be executed by the compute unit 908. To execute these waves, each compute unit is connected to one or more shared caches 910 that each include a volatile memory, non-volatile memory, or both accessible by one or more compute units 908. These shared caches 910, for example, are configured to store data (e.g., register files, values, operands, instructions, variables) used in the execution of one or more waves, data resulting from the performance of one or more waves, or both. Because a shared cache 910 is accessible by two or more compute units 908, a first compute unit 908 is enabled to provide results from the execution of a first wave to a second compute unit 908 executing a second wave. Though the example embodiment presented in FIG. 9 shows AU 900 as including 32 compute units (908-1 to 908-32), in other implementations, AU 900 can include any number of compute units 908.

Each compute unit 908 includes one or more single instruction, multiple data (SIMD) units 914, a scalar unit 916, vector registers 918, scalar registers 920, local data share 922, instruction cache 924, data cache 926, texture filter units 928, texture mapping units 930, or any combination thereof. A SIMD unit 914 (e.g., a vector processor) is configured to concurrently perform multiple instances of the same operation for a wave. For example, a SIMD unit 914 includes two or more lanes each including an arithmetic logic unit (ALU) and each configured to perform the same operation for the threads of a wave. Though the example embodiment presented in FIG. 9 shows a compute unit 908 including three SIMD units (914-1, 914-2, 914-N) representing an N number of SIMD units, in other implementations, a compute unit 908 can include any number of SIMD units 914. Further, as an example, the size of a wavefront supported by AU 900 is based on the number of SIMD units 914 included in each compute unit 908. To determine the operations performed by the SIMD units 914, each compute unit 908 includes vector registers 918 formed from one or more physical registers of AU 900. These vector registers 918 are configured to store data (e.g., operands, values) used by the respective lanes of the SIMD units 914 to perform a corresponding operation for the wave. Additionally, each compute unit 908 includes a scalar unit 916 configured to perform scalar operations for the wave. As an example, the scalar unit 916 includes an ALU configured to perform scalar operations. To support the scalar unit 916, each compute unit 908 includes scalar registers 920 formed from one or more physical registers of accelerator unit 900. These scalar registers 920 store data (e.g., operands, values) used by the scalar unit 916 to perform a corresponding scalar operation for the wave.

Further, each compute unit 908 includes a local data share 922 formed from a volatile memory (e.g., random-access memory) accessible by each SIMD unit 914 and the scalar unit 916 of the compute unit 908. That is to say, the local data share 922 is shared across each wave concurrently executing on the compute unit 908. The local data share 922 is configured to store data resulting from the execution of one or more operations for one or more waves, data (e.g., register files, values, operands, instructions, variables) used in the execution of one or operations for one or more waves, or both. As an example, the local data share 922 is used as a scratch memory to store results necessary for, aiding in, or helpful for the performance of one or more operations by one or more SIMD units 914. The instruction cache 924 of a compute unit 908, for example, includes a volatile memory, non-volatile memory, or both configured to store the instructions to be executed for one or more waves to be executed by the compute unit 908. Further, the data cache 926 of a compute unit 908 includes a volatile memory, non-volatile memory, or both configured to store data (e.g., register files, values, operands, variables) used in the execution of one or more waves by the compute unit 908. The instruction cache 924, data cache 926, shared caches 910, and a system memory, for example, are arranged in a hierarchy based on the respective sizes of the caches. As an example, based on such a cache hierarchy, a compute unit 908 first requests data from a controller of a corresponding data cache 926. Based on the data not being in the data cache 926, the data cache 926 requests the data from a shared cache 910 at the next level of the cache hierarchy. The caches then continue in this way until the data is found in a cache or requested from the system memory, at which point, the data is returned to the compute unit 908. Additionally, each compute unit 908 includes one or more texture mapping units 930 each including circuitry configured to map textures to one or more graphics objects (e.g., groups of primitives) generated by the compute units 908. Further, each compute unit 908 includes one or more texture filter units 928 each having circuitry configured to filter the textures applied to the generated graphics objects. For example, the texture filter units 928 are configured to perform one or more magnification operations, anti-aliasing operations, or both to filter a texture.

Additionally, to help perform instructions for one or more workgroups, AU 900 includes acceleration circuitry 912. Such acceleration circuitry 912 includes hardware (e.g., fixed-function hardware) configured to execute one or more instructions for one or more workgroups. As an example, acceleration circuitry 912 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 906 is configured to update one or more physical registers 932 of AU 900 associated with the hardware. In some cases, AU 900 includes one or more compute units 908 grouped into one or more shader engines 934. Referring to the embodiment presented in FIG. 9, for example, AU 900 includes compute units 908-1 to 908-16 grouped in a first shader engine 934-1 and compute units 908-17 to 908-32 grouped in a second shader engine 934-2. Such shader engines 934, for example, are configured to execute one or more workgroups (e.g., one or more compute kernels) for an application and include one or more compute units 908, graphics processing hardware (e.g., primitive assemblers, rasterizers), one or more shared caches 910, render backends, or any combination thereof. Though the embodiment presented in FIG. 9 shows AU 900 as including two shader engines (934-1, 934-2), in other implementations, AU 900 can include any number of shader engines (934-1, 934-2).

The first GPU 110 (GPU0), the second GPU 112 (GPU1), the third GPU 114 (GPU2), and the fourth GPU 116 (GPU3) may be included within the AU 900 or may be implemented by the AU 900.

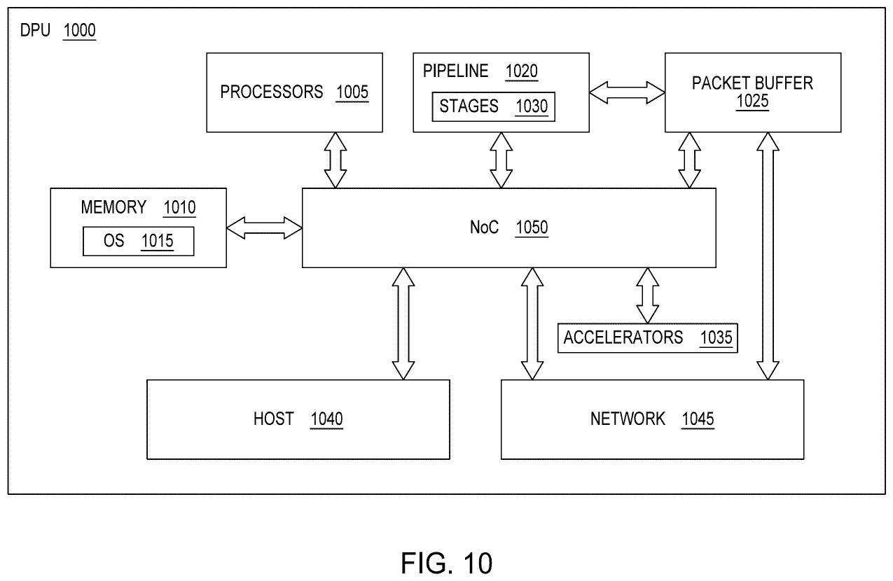

FIG. 10 is a block diagram of a data processing unit (DPU) that may be used to implement a network interface controller/card (NIC), in accordance with some embodiments.

In one embodiment, the DPU 1000 is a programmable processor designed to efficiently handle data-centric workloads such as data transfer, reduction, security, compression, analytics, and encryption, at scale in data centers. The DPU 1000 can improve the efficiency and performance of data centers by offloading workloads from a host central processing unit (CPU) or graphic processing units (GPUs). While CPUs and GPUs can specialize on compute, the DPU may specialize in data movement. The DPU 1000 can communicate with host CPUs and GPUs to enhance computing power and the handling of complex data workloads.

The DPU 1000 includes a plurality of processors 1005. In one embodiment, the processors 1005 include any number of processing cores. In one embodiment, the processors 1005 may be CPUs. The processors 1005 can form one or more CPU core complexes. The processors 1005 can be any hardware circuitry that uses an instruction set architecture (ISA) to process data, such as a complex instruction set computer (CISC) or reduced instruction set computer (RISC).

The memory 1010 can include volatile or non-volatile memory such as random access memory (RAM), high bandwidth memory (HBM), and the like. The memory 1010 can include an operating system (OS) 1015 that is separate from the host OS.

In one embodiment, the DPU may be in (or be used to implement) a network interface controller/card (NIC) such as a SmartNIC that processes packets before they are forwarded to a host (e.g., a host CPU or GPU). In one embodiment, the DPUs 1000 are fully programmable P4 DPUs. The DPU 1000 includes multiple pipelines 1020 (which can be the same type or different types) for processing received network packets stored in a packet buffer 1025. In this example, the pipelines 1020 has direct connections to the packet buffer 1025.

The pipelines 1020 can operate in parallel. Further, the pipelines 1020 can be the same type of pipeline (e.g., perform the same tasks). In other embodiments, the DPU 1000 may have different types of pipelines 1020. For example, the DPU 1000 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 1020 include multiple stages 1030 where received packet data is processed at each stage 1030 before being passed to the next stage. This packet data could be the entire packet or just a portion of the packet. For example, a parser in the DPU 1000, which is upstream from the pipelines 1020, may parse out a particular portion of a received packet (e.g., a packet header vector (PHV)) which is then sent to the one of the pipelines 1020.

The stages 1030 can include circuitry or hardware. In one embodiment, the stages 1030 can be programmed using a pipeline programming language, such as P4. In one example, the stages 1030 in one pipeline 1020 perform the same functions of the stages 1030 in another pipeline 1020. However, in other embodiments, the stages may perform different functions.

In addition to the stages, the pipelines 1020 may each include memory, which can be referred to as local memory. This memory can store local tables that indicate how, or if, a particular packet should be processed at the stages 1030. For example, one of the stages in the pipelines 1020 can perform a lookup to read a policing entry in a table to determine whether an entity associated with the packet has exceeded a rate limit (e.g., a packet rate limit, a data rate limit, or both).

The DPU 1000 can include accelerators 1035 to perform specialized tasks associated with data movement. The accelerators 1035 can include a cryptography accelerator, a data compression accelerator, as well as accelerators for performing regex or dedupe.

To communicate with the host and a network, the DPU 1000 includes host input/output (IO) 1040 and network IO 1045. The host IO 1040 can include a PCIe interface, or any suitable protocol for communicating with a CPU or GPU in the host. The network IO 1045 can include Ethernet interfaces, and the like for communicating with a network.

The DPU 1000 includes a network on chip (NoC) 1050 for interconnecting the various components discussed above. While a NoC is disclosed, the DPU 1000 can include any suitable on-chip network. While some components in the DPU 1000 may rely on the NoC 1050 to communicate with other components, the DPU 1000 can also include connections between components that bypass the NoC 1050. For example, the packet buffer 1025 can have a connection to the network IO 1045 that bypasses the NoC 1050. Similarly, the pipelines 1020 can exchange packet data with the packet buffer 1025 without having to rely on the NoC 1050. However, to transfer data to the processors 1005, the pipelines 1020 may use the NoC 1050.

In one embodiment, the DPU 1000 includes security and management features such as offering a hardware root of trust, secure boot, and the like.

The DPU 1000 may be in (or be used to implement) a NIC that processes packets before they are forwarded to a host (e.g., a host CPU or GPU). The NIC may be one or more of the first smart NIC 140 (NIC0), the second smart NIC 142 (NIC1), the third smart NIC 144 (NIC2), the fourth smart NIC 146 (NIC3), the fifth smart NIC 148 (NIC4), the sixth smart NIC 150 (NIC5), the seventh smart NIC 152 (NIC6), and the eight smart NIC 154 (NIC7).

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
a plurality of hardware accelerators including at least one mixture-of-experts (MoE) layer having multiple experts; and
a plurality of network interface cards (NICs) coupled to the plurality of hardware accelerators, wherein at least one expert of the multiple experts is offloaded from the plurality of hardware accelerators to the plurality of NICs.

2. The system of claim 1, wherein the plurality of hardware accelerators are graphics processing units (GPUs).

3. The system of claim 1, wherein all of the multiple experts are offloaded from the plurality of hardware accelerators to the plurality of NICs.

4. The system of claim 1, wherein a subset of the multiple experts are selectively offloaded from the plurality of hardware accelerators to the plurality of NICs.

5. The system of claim 4, wherein the subset of the multiple experts are selected based on memory and computational capacity available on the plurality of NICs.

6. The system of claim 1, wherein the multiple experts are designated as either hot experts or cold experts.

7. The system of claim 6, wherein the cold experts are offloaded from the plurality of hardware accelerators to the plurality of NICs.

8. The system of claim 6, wherein the hot experts are duplicated for each of the plurality of hardware accelerators.

9. The system of claim 6, wherein a portion of the multiple experts are designated as the hot experts by gathering expert temperature statistics to create a global view of expert temperatures.

10. The system of claim 1, wherein at least one expert of the multiple experts of the MoE layer is sharded across the plurality of hardware accelerators.

11. The system of claim 10, wherein a subset of the multiple experts designated as sharded experts are offloaded to the plurality of NICs.

12. A method comprising:
providing at least one mixture-of-experts (MoE) layer having multiple experts to a plurality of hardware accelerators coupled to a plurality of network interface cards (NICs); and
offloading at least one expert of the multiple experts from the plurality of hardware accelerators to the plurality of NICs.

13. The method of claim 12, wherein the plurality of hardware accelerators are graphics processing units (GPUs).

14. The method of claim 12, wherein a subset of the multiple experts are selectively offloaded from the plurality of hardware accelerators to the plurality of NICs.

15. The method of claim 14, wherein the subset of the multiple experts are selected based on memory and computational capacity available on the plurality of NICs.

16. The method of claim 12, wherein the multiple experts are designated as either hot experts or cold experts.

17. The method of claim 16, wherein the cold experts are offloaded from the plurality of hardware accelerators to the plurality of NICs.

18. The method of claim 16, wherein the hot experts are duplicated for each of the plurality of hardware accelerators.

19. A system comprising:
a plurality of hardware accelerators; and
a neural network architecture including multiple experts distributed across the plurality of hardware accelerators, wherein at least one expert of the multiple experts is offloaded from the plurality of hardware accelerators to a plurality of network interface cards (NICs).

20. The system of claim 19, wherein the multiple experts are designated as either hot experts or cold experts, the cold experts being offloaded from the plurality of hardware accelerators to the plurality of NICs and the hot experts being duplicated for each of the plurality of hardware accelerators.
